(19) United States
(12) Patent Application Publication
(10) Pub. No.: US 2026/0210317 A1
(43) Pub. Date: Jul. 23, 2026

(54) INJECTOR FOR GASEOUS OR LIQUID FUEL

(71) Applicant: Robert Bosch GmbH, Stuttgart (DE)

(72) Inventor: Alexander Fuchs, Adnet (AT)

(21) Appl. No.: 19/140,057

(22) PCT Filed: Nov. 22, 2023
(86) PCT No.: PCT/EP2023/082677

§ 371 Date: Aug. 8, 2025

(30) Foreign Application Priority Data
Dec. 19, 2022 (DE) 10 2022 213 824.4

(51) Int. Cl. F02M 21/02

(52) U.S. Cl. CPC F02M 21/0254; F02M 21/0257; F02M 21/0275; F02M 21/0278

(57) ABSTRACT

Injector for dispensing gaseous or liquid fuel, having a housing (1), in which a fuel chamber (5) which is fillable with the fuel is formed, and having a piston-type valve element (6), which interacts with a valve seat (7) to open and close a dispensing orifice (9) of the fuel chamber (5), wherein the valve element (6) is movable in an opening direction by an actuator (20), against the force of a closing spring (16). The valve element (6) is surrounded at least in sections by a corrugated bellows (11), which delimits a lubricant chamber (10), in which a lubricant (24) is present for lubricating the valve element (6). A compensating chamber (23) connected to the lubricant chamber (10) is formed in the housing (1), wherein the compensating chamber (23) is filled partly with the lubricant (24) and partly with a gas (25).

### BACKGROUND

The invention relates to an injector as used for the metered dispensing of liquid or gaseous fuel, in particular, for dispensing fuel directly into a combustion chamber or the intake tract of an internal combustion engine.

To operate internal combustion engines, the required gaseous or liquid fuel is metered either into the intake tract of the internal combustion engine or directly into a combustion chamber of the internal combustion engine. With direct metering into the combustion chamber, the fuel must be dispensed by an injector very precisely at the desired time and in the correct quantity. For this purpose, the injector has a movable valve element that is movable via an electromagnet or another electric actuator, wherein a dispensing orifice is actuated to open or closed by the movement of the valve element. Such an injector is known, for example, from DE 10 2021 200 689 A1 and has a piston-type valve element that is arranged in the housing of the injector, such that it is longitudinally displaceable. The valve element is surrounded by a lubricant chamber which is sealed by a corrugated bellows against a fuel chamber through which the fuel flows to the dispensing orifice. The lubricant ensures low-friction movement of the valve element and thus precise metering of the fuel over its service life.

In the case of injectors with an outward-opening valve element, this moves out of the housing with the opening stroke movement, wherein the lubricant chamber delimited by the corrugated bellows is enlarged. In the subsequent closing movement, the lubricant chamber is reduced again accordingly. This change in size is made possible by the corrugated bellows, which is flexible in the longitudinal direction and is fixedly connected to the valve element at one end. However, as the lubricant is liquid and therefore incompressible, there must be a compensating chamber to receive the lubricant displaced from the lubricant chamber and then release it again.

### SUMMARY

The injector according to the invention for dispensing gaseous or liquid fuel has the advantage that a compensating chamber is formed in a simple manner, and thus the function of the injector is ensured over its service life. For this purpose, the injector has a housing in which a fuel chamber that is fillable with the fuel is formed, and in which a piston-type valve element is arranged that interacts with a valve seat for orifice and closing a dispensing orifice of the fuel chamber. The valve element is movable in an opening direction by an actuator against the force of a closing spring and is surrounded, at least in sections, by a corrugated bellows which delimits a lubricant chamber in which a lubricant is present to lubricate the valve element. Furthermore, a compensating chamber connected to the lubricant chamber is formed in the housing, wherein the compensating chamber is partly filled with the lubricant and partly with a gas.

During the opening movement of the valve element in the longitudinal direction, the corrugated bellows is extended, as only one end of the corrugated bellows is connected to the valve element to allow the valve element to move and at the same time ensure that the lubricant chamber is sealed. This changes the volume of the lubricant chamber in the section of the corrugated bellows. As the lubricant is liquid and therefore largely incompressible, lubricant must flow in from a compensating chamber. Conversely, the volume decreases during the closing movement and the differential volume must be able to flow out of this part of the lubricant chamber into the compensating chamber. The compensating chamber must therefore receive or release a certain volume of lubricant during the opening and closing movement of the valve element. The gas in the lubricant chamber provides the necessary elasticity, as the lubricant flowing into the lubricant chamber compresses the gas and the gas expands again accordingly as the lubricant flows out, wherein a pressure caused by the compression of the gas is also exerted on the lubricant. Volume changes in the lubricant due to temperature changes may also be compensated for by the connection with the compensating chamber.

In an advantageous embodiment of the invention, the connection between the lubricant chamber and the compensating chamber comprises a connecting tube which projects into the compensating chamber. Advantageously, a sufficient amount of lubricant is always present in the compensating chamber such that the opening of the connecting tube is covered by the lubricant. Since the gas rises upward due to gravity, a sufficiently filled lubricant chamber ensures that no gas enters the connecting tube—and thus the lubricant chamber section within the nozzle body—regardless of the orientation of the injector. Otherwise, the lubrication of the valve element could be impaired, resulting in functional impairments.

In a further advantageous embodiment, a diaphragm is arranged in the compensating chamber, which divides the compensating chamber into two mutually sealed sections, wherein lubricant is present in the section connected to the lubricant chamber and gas is present in the other section. The function is identical to the embodiment without diaphragm, but the diaphragm prevents the lubricant and gas from mixing and thus prevents gas from entering the lubricant chamber. Advantageously, the diaphragm may be biased into the gas by the pressure in the lubricant chamber, i.e., the diaphragm projects convexly into the gas volume in order to generate a bias and thereby produce a certain pressure in the lubricant, ensuring reliable filling of the lubricant chamber.

In a further advantageous embodiment, only lubricant and gas are present in the compensating chamber. Further media, for example, to separate these two media, are not necessary.

Advantageously, the lubricant is liquid. In particular, a lubricating oil may be used as a lubricant that has the necessary lubricating properties to ensure low-friction movement of the valve element.

### BRIEF DESCRIPTION OF THE DRAWINGS

Two exemplary embodiments of the invention are shown in the drawing. Shown are

FIG. 1 a longitudinal section through an injector according to the invention and

FIG. 2 a further exemplary embodiment, wherein the injector is only shown in the section of the compensating chamber according to section II in FIG. 1.

### DETAILED DESCRIPTION

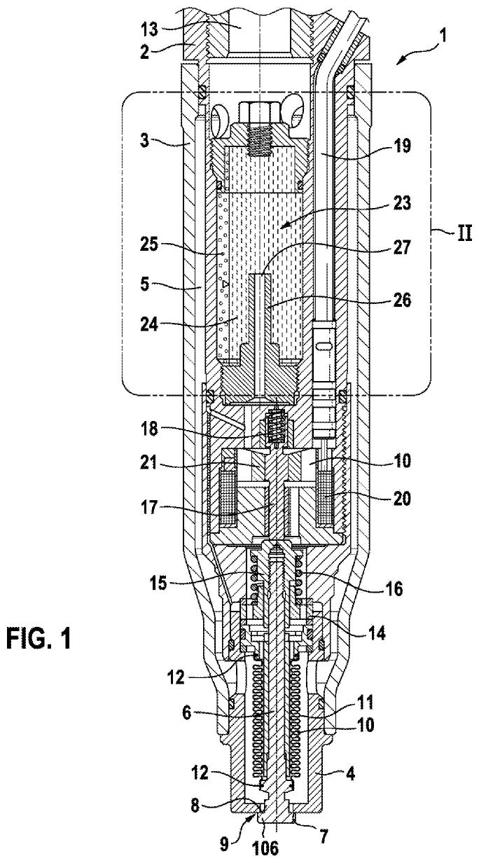

In FIG. 1 a longitudinal section of an injector according to the invention is shown, as it may be used for the metered dispensing of liquid or gaseous fuel. The injector has a housing 1 which comprises a multi-part valve body 2, a casing tube 3, and a nozzle body 4. The valve body 2 is also made up of several parts, wherein the individual parts are connected to each other in a gas- and liquid-tight manner, and extends to the nozzle body 4, which forms the combustion-chamber-side end of the injector. A fuel chamber 5 is formed between the casing tube 3, which surrounds the valve body 2, and may be filled with fuel via a fuel inlet 13 formed in the valve body 2. The fuel chamber 5 extends into the nozzle body 4, in which a piston-type valve element 6 is arranged so as to be longitudinally displaceable, which projects out of the nozzle body 4 and has a valve disk 106 with a sealing surface 8. The sealing surface 8 interacts with a valve seat 7 formed on the nozzle body 4 to open and close an annular dispensing orifice 9, which is actuated to open by the longitudinal movement of the valve element 6 between the valve seat 7 and the sealing surface 8.

The end of the valve element 6 facing away from the valve seat 7 is received in a guide sleeve 15, between which and a support part 14 a closing spring 16 is clamped under compressive preload. The closing spring 16 exerts a closing force on the valve element 6 in the direction of the closed position, in which the sealing surface 8 is in contact with the valve seat 7. On the guide sleeve 15, facing away from the valve element 6, there is a pin 17 which is connected to a solenoid armature 21 and interacts with a damping element 18 in order to slow down the contact of the sealing surface 8 on the valve seat 7 and thus reduce the mechanical load in this area and also the noise development. An actuator in the form of an electromagnet 20 is arranged in the valve body 2 at the level of the pin 17, which exerts a longitudinal force on the solenoid armature 21 when energized and thus also on the valve element 6 via the pin 17, in order to push it out of the nozzle body 4 in the opening direction against the force of the closing spring 16 and open the dispensing orifice 9. The electromagnet 20 is supplied with the necessary electrical voltage by a power source, not shown, via an electrical connection 19.

The valve element 6 is surrounded inside the nozzle body 4 by a corrugated bellows 11, which is connected to the valve element 6 in a liquid-tight manner at its valve seat end by a welded connection 12, and to the valve body 2 at the other end. The corrugated bellows 11 delimits a lubricant chamber 10 surrounding the valve element 6, which extends past the guide sleeve 15 and the pin 17 into a compensating chamber 23 in the valve body 2. The connection from the lubricant chamber 10 to the compensating chamber 23 is formed by a connecting tube 26, which projects into the compensating chamber 23, in this exemplary embodiment approximately to the center of the compensating chamber 23. In order to keep the guidance of the valve element 6 in the guide sleeve 15, as well as other areas of the valve element 6 where friction between components occurs, largely free of friction, the lubricant chamber 10 is filled with a lubricant. The lubricant may be a lubricating oil, for example, a mineral lubricating oil with a relatively low viscosity. So much lubricant 24 is filled into the lubricant chamber 10 and the associated compensating chamber 23 that the lubricant chamber 10 is largely—but not completely—filled with lubricant and gas is still present in the compensating chamber 23 in addition to the lubricant. In the fully assembled injector, the lubricant chamber 10 and compensating chamber 23 are sealed to the outside, such that the lubricant does not mix with the fuel.

The function of the injector is as follows: In the injector, the fuel chamber 5 is filled with gaseous or liquid fuel, which is present there under injection pressure. At the start of an injection process, the electromagnet 20 is de-energized, such that the closing spring 16 presses the valve element 6 with the valve disk 106 against the valve seat 7 and closes the fuel chamber 5. If fuel is to be dispensed, the electromagnet 20 is energized and its magnetic force pulls the solenoid armature 21 against the force of the closing spring 16 in the direction of the valve seat 7, whereby the valve element 6 is pushed outwards into its opening position. The dispensing orifice 9 between the valve seat 7 and the valve disk 106 is actuated to open, fuel is discharged from the fuel chamber 5, for example, into a combustion chamber of an internal combustion engine. During the opening movement of the valve element 6, the corrugated bellows 11 is extended, which enlarges the lubricant chamber 10. To compensate, lubricant flows from the compensating chamber 23 into the lubricant chamber 10, wherein the gas 25 in the compensating chamber 23 expands accordingly. To terminate the injection, the power supply to the electromagnet 20 is interrupted, and the closing spring 16 pushes the valve element 6 back into its closed position. In the process, the corrugated bellows 11 contracts again, thereby reducing the volume of the lubricant chamber 10, which forces the corresponding amount of lubricant back into the compensating chamber 23, wherein the gas is compressed in order to compensate for the additional lubricant volume.

Due to the position of the connecting tube in the middle of the compensating chamber 23, it is ensured, given appropriate filling with lubricant 24, that the gas 25 does not enter the connecting tube 26 and thus does not reach the lubricant chamber 10, regardless of the orientation of the injector with respect to gravity. In FIG. 1, the gas 25 is shown on the left-hand side for illustration purposes, where it would collect if the injector were turned sideways by 90°.

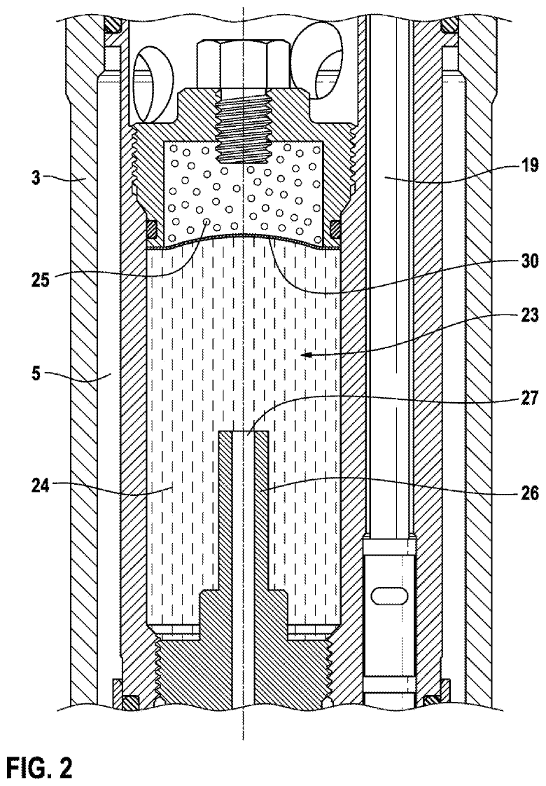

In FIG. 2 a further exemplary embodiment of the injector according to the invention is shown, which differs from the previous exemplary embodiment only in the design of the compensating chamber 23, which is why only this section of the injector is shown in longitudinal section, which is labeled II in FIG. 1. In this exemplary embodiment, gas 25 and lubricant 24 are separated in the compensating chamber 23 by a diaphragm 30, which is made of a flexible, fuel-resistant material. The function is identical to the injector shown in FIG. 1, but here the lubricant flowing into the compensating chamber 23 presses the diaphragm 30 into the gas 25, causing the diaphragm 30 to deform convexly. As the diaphragm 30 is flexible, it may exert a certain pressure on the lubricant in addition to the pressure of the gas 25 in order to keep it in the lubricant chamber 10 at all times. When using the diaphragm 30, the connecting tube 26 may be omitted, as mixing of gas and lubricant is prevented in any position of the injector, regardless of the amount of lubricant in the compensating chamber 23.

In addition to compensating for the lubricant volume during the opening and closing movement of the valve element 6, the compensating chamber 23 also serves to compensate for volume changes of the lubricant caused by thermal expansion of the lubricant or the surrounding components.

1. An injector for dispensing gaseous or liquid fuel, having a housing (1) in which a fuel chamber (5) fillable with the fuel is formed, and having a piston-type valve element (6) which interacts with a valve seat (7) for opening and closing a dispensing orifice (9) of the fuel chamber (5), wherein the valve element (6) is movable in an opening direction by an actuator (20) against a force of a closing spring (16), and with a corrugated bellows (11) which surrounds the valve element (6) at least in sections, and which delimits a lubricant chamber (10) in which a lubricant (24) for lubricating the valve element (6),
wherein
a compensating chamber (23) connected to the lubricant chamber (10) is formed in the housing (1), wherein the compensating chamber (23) is partially filled with the lubricant (24) and partially filled with a gas (25).

2. The injector according to claim 1, wherein the connection between the lubricant chamber (10) and the compensating chamber (23) comprises a connecting tube (26) which projects into the compensating chamber (23).

3. The injector according to claim 2, wherein the compensating chamber contains such an amount of lubricant (24) that a pipe opening (27) of the connecting tube (26) is always covered with lubricant.

4. The injector according to claim 1, wherein the lubricant (24) is liquid.

5. The injector according to claim 1, wherein the corrugated bellows (11) is fixedly connected at one end to the valve element (6), such that the corrugated bellows (11) is compressed during a longitudinal movement of the valve element (6).

6. The injector according to claim 1, wherein a flexible diaphragm (30) is arranged in the compensating chamber (23) and separates the gas (25) from the lubricant (24).

7. The injector according to claim 6, wherein the flexible diaphragm (30) is biased into the gas (25) by the lubricant (24).

8. The injector according to claim 1, wherein only lubricant and gas (25) are present in the compensating chamber (10).
